(19) United States
(12) Patent Application Publication
(10) Pub. No.: US 2010/0332697 A1
(43) Pub. Date: Dec. 30, 2010

(54) STORAGE DEVICE AND STORAGE DEVICE ASSEMBLY

(75) Inventor: MIN ZHENG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., SHENZHEN CITY (CN); HON HAI PRECISION INDUSTRY CO., LTD., TU-CHENG (TW)

(21) Appl. No.: 12/578,157

(22) Filed: Oct. 13, 2009

(30) Foreign Application Priority Data
Jun. 24, 2009 (CN) 200910303577.9

(51) Int. Cl. G06F 3/00; G06F 12/02

(52) U.S. Cl. 710/51; 711/103; 711/E12.008

(57) ABSTRACT

A storage device includes a USB connector, a storage module, a first USB receiver, and a multiplexer. The USB connector is configured for connected to a computer. The storage module is configured for storing data. The first USB receiver is configured to receive a second storage device. The multiplexer is connected to the USB connector and the first USB receiver, and is capable of accessing the storage module, wherein the multiplexer is capable of accessing the storage module and the second storage device at the same time when the USB connector is connected to the computer and the second storage device is connected to the first USB receiver.

### BACKGROUND

1. Technical Field

The disclosure generally relates to storage devices, especially to a storage device capable of connecting to another storage device and a storage device assembly.

2. Description of Related Art

Usually, portable data storage devices, such as USB flash drives are widely used for data transmitting. These kinds of data storage devices have a limited capacity. If target data exceed the capacity of the data storage device, the target data cannot all be stored.

### BRIEF DESCRIPTION OF THE DRAWINGS

FIG. 1 is a block diagram of a storage device assembly.

FIG. 2 is a flowchart of using a storage device assembly.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

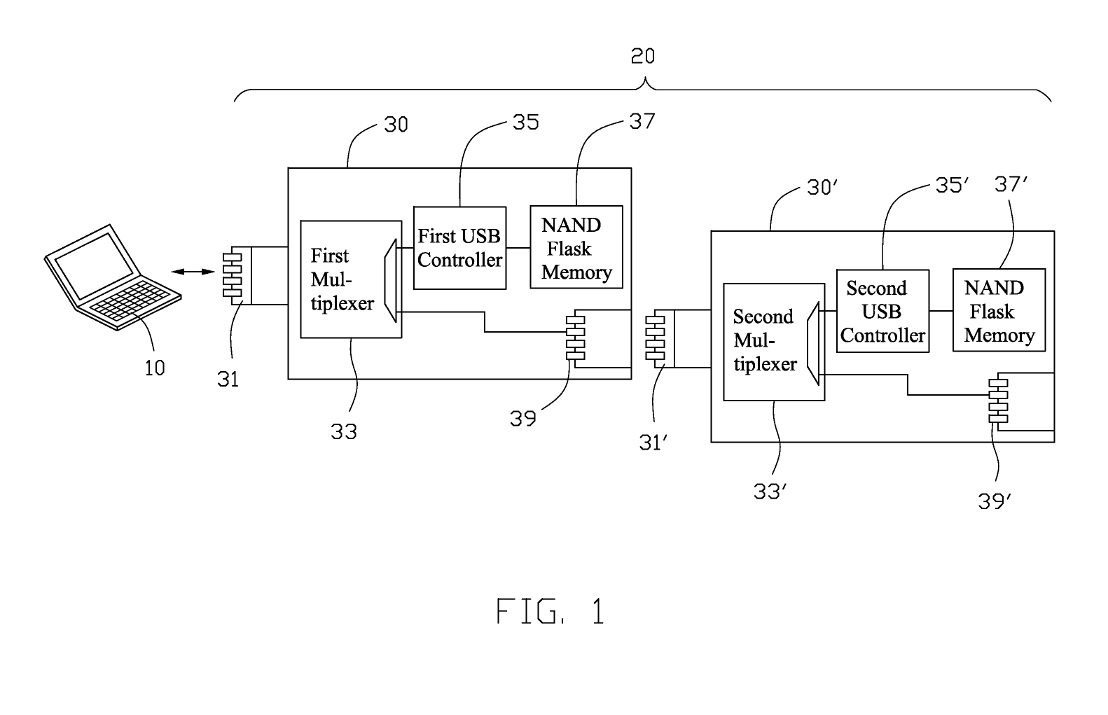

Referring to FIG. 1, a storage device assembly 20 includes a first storage device 30 and a second storage device 30′.

The first storage device 30 includes a first universal serial bus (USB) connector 31, a first multiplexer 33, a first USB controller 35 connected to the first multiplexer 33, a first storage module, and a first USB receiver 39. The second storage device 30′ includes a second USB connector 31′, a second multiplexer 33′, a second USB controller 35′ connected to the second multiplexer 33′, a second storage module 37′, and a second USB receiver 39′. In one embodiment, the first and second storage modules are respectively NAND flash memories 37, 37′. The first and second storage device 30, 30′ have the same structure. Alternatively, the second storage device 30′ may have different structure from the first storage device 30, such as a normal USB storage device.

The first USB connector 31 is configured to connect to a computer 10. The second USB connector 31′ is configured to connect to the first USB receiver 39 of the first storage device 30.

The first multiplexer 33 is connected to the first USB connector 31 and the first USB receiver 39 of the first storage device 30. The second multiplexer 33′ is capable of accessing the NAND flash memory 37′ of the second storage device 30′. The first USB connector 31 is connected to the computer 10 and the second USB connector 31′ is connected to the first USB receiver 39 of the first storage device 30. Thereby the first multiplexer 33 is capable of accessing the NAND flash memory 37 and the second storage device 30′. The first USB controller 35 is configured to control data transmission speed between the NAND flash memory 37 and the first multiplexer 33.

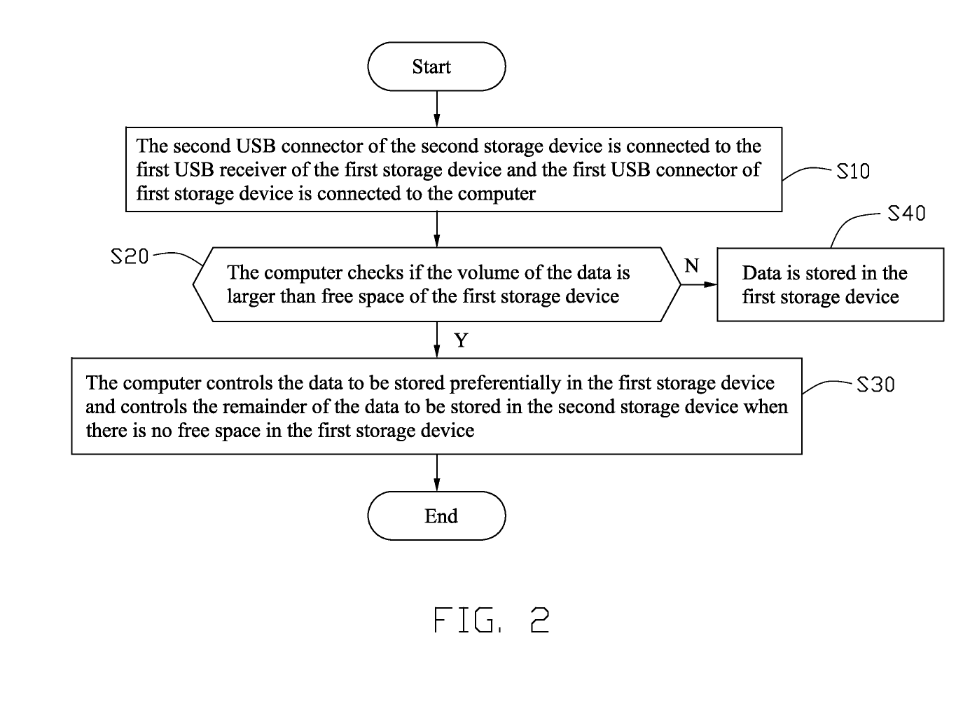

Referring to FIG. 2, the working principle for using the storage device assembly 20 to store data includes the following steps.

In step S10: the second USB connector 31′ of the second storage device 30′ is connected to the first USB receiver 39 of the first storage device 30 and the first USB connector 31 of first storage device 30 is connected to the computer 10.

In step S20: the computer 10 checks if the volume of the data is larger than free space of the first storage device 30. If so, go to S30, if not, go to S40.

In step S30: the computer 10 controls the data to be stored preferentially in the first storage device 30 and controls the remainder of the data to be stored in the second storage device 30′ when there is no free space in the first storage device 30.

In step S40: data is stored in the first storage device 30.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A storage device, comprising:
a USB connector configured to connect to a computer;
a storage module configured to store data;
a first USB receiver configured to receive a second storage device; and
a multiplexer connected to the USB connector and the USB receiver capable of accessing the storage module, wherein the multiplexer is capable of accessing the storage module and the second storage device at the same time when the USB connector is connected to the computer and the second storage device is connected to the first USB receiver.

2. The storage device of the claim 1 further comprising a USB controller connected between the multiplexer and the storage module, wherein the USB controller is configured to control data transmission speed between the storage module and the multiplexer.

3. The storage device of the claim 1, wherein the storage module is a flash memory.

4. The storage device of the claim 3, wherein the flash memory is an NAND flash memory.

5. A storage device assembly, comprising:
a first storage device, the first storage device comprising:
a first USB connector configured to connect to a computer;
a first storage module configured to store data;
a first USB receiver; and
a first multiplexer connected to the first USB connector and the first USB receiver of the first storage device capable of accessing the first storage module, wherein the first storage device is capable of being accessed by the computer via the first multiplexer when the first USB connector of the first storage device is connected to the computer; and
a second storage device, the second storage device comprising a second connector connected to the first USB receiver of the first storage device.

6. The storage device assembly of the claim 5, wherein the first storage device comprises a first USB controller connected between the first multiplexer and the first storage module, and the first USB controller is configured to control data transmission speed between the first storage module and the first multiplexer.

7. The storage device assembly of the claim 5, wherein the first storage module is a flash memory.

8. The storage device assembly of the claim 7, wherein the flash memory is an NAND flash memory.

9. The storage device assembly of the claim 5, wherein the second storage device further comprises a second multiplexer, a second storage module and a second USB controller connected between the second multiplexer and the second storage module of the second storage device, wherein the second USB controller of the second storage device is configured to control data transmission speed between the second storage module and the second multiplexer of the second storage device.

10. The storage device assembly of the claim 5, wherein the second storage device further comprises a second USB receiver for receiving a third USB connector of a third storage device.

11. The storage device assembly of the claim 10, wherein the second storage device further comprises a multiplexer connected to the second USB connector capable of accessing the second storage module of the second storage device, wherein the multiplexer is capable of accessing the second storage module of the second storage device and the third storage device at the same time when the second USB connector is connected to the first USB receiver of the first storage device and the third USB connector of the third storage device is connected to the second USB receiver of the second storage device.
